(19) United States
(12) Patent Application Publication
(10) Pub. No.: US 2014/0252709 A1
(43) Pub. Date: Sep. 11, 2014

(54) Clean Cut

(71) Applicant: Robert Allen Crimmins, Tower Lakes, IL (US)

(72) Inventor: Robert Allen Crimmins, Tower Lakes, IL (US)

(21) Appl. No.: 13/785,679

(22) Filed: Mar. 5, 2013

(51) Int. Cl. A47J 47/00

(52) U.S. Cl. CPC A47J 47/005
USPC 269/14; 269/13

(57) ABSTRACT

A cutting board assembly including a drip tray having a receptacle and a cutting board removably associated with the receptacle of the drip tray whereby liquid that flows over the edge of the cutting board will flow info and be retained in the receptacle of the drip tray. The cutting board may include a plurality of slots extending through the cutting board that are in fluid communication with the receptacle of the drip tray and/or a plurality of grooves that are in communication with the edge of the cutting board.

### FIELD OF THE INVENTION

This invention relates generally to consumer food preparation and more particularly to cutting boards used in preparing food.

### BACKGROUND

Standard cutting boards have a culling surface with either no groove or a small groove that extends parallel to and along the edge of the cutting board that is intended to prevent liquid from flowing over the edge of the cutting board. Liquid from a food product, such as a piece of meat or a freshly washed head of lettuce, can fill the groove up such that excess liquid will overflow the groove and will flow over the edge of the cutting board onto other surfaces such as a countertop or floor. When liquid from a food product gets on a countertop or floor it creates sanitary issues, and when such liquid flows off the countertop and onto the floor it creates a hazardous slipping condition. In addition, such overflow liquids, such as juices, can no longer be further used for preparation of gravy, sauces and other food products.

### BRIEF DESCRIPTION OF THE DRAWING FIGURES

FIG. 1 is a top plan view of the cutting board assembly showing the curling board in association with the drip tray;

FIG. 2 is a front elevations view of the cutting board assembly;

FIG. 3 is a top plan view of the cutting board assembly shown with a portion of the cutting broad broken away to show a portion of the underlying drip tray;

FIG. 4 is a front elevational view of the cutting board assembly with a portion of the cutting board assembly shown in cross-section;

FIG. 5 is a top plan view of the drip tray of the cutting board assembly;

FIG. 6 is a cross-sectional view of the drip tray taken along line 6-6 of FIG. 5;

FIG. 7 is a bottom view of the drip tray;

FIG. 8 is a top plan view of an alternate embodiment of the drip tray;

FIG. 9 is a cross-sectional view taken along line 9-9 of FIG. 8;

FIG. 10 is a top plan view of the cutting board assembly showing the cutting board in association with the drip tray of FIG. 8 and with, a portion of the cutting board cut away;

FIG. 11 is front elevational view of the cutting board assembly of FIG. 11 shown with a portion of the drip tray cut away;

FIG. 12 is a top plan view of the cutting board;

FIG. 13 is bottom view of die cutting board;

FIG. 14 is a cross-sectional view taken along line 14-14 of FIG. 13;

FIG. 15 is a cross-sectional view taken along line 15-15 of FIG. 14;

FIG. 16 is a top plan view of an alternate embodiment of the cutting board; and

FIG. 17 is a cross-sectional view taken along line 17-17 of FIG. 16.

### DETAILED DESCRIPTION

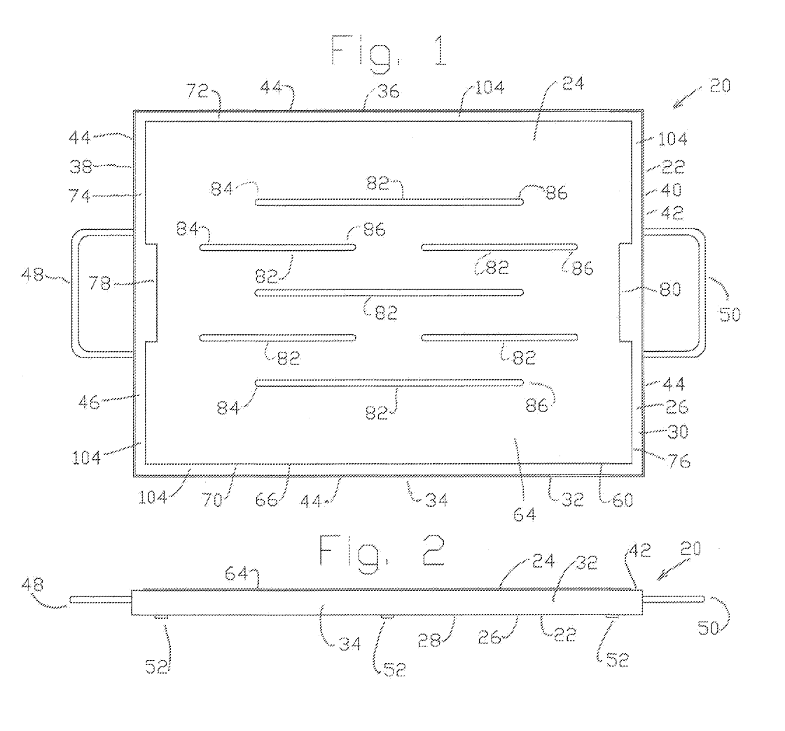

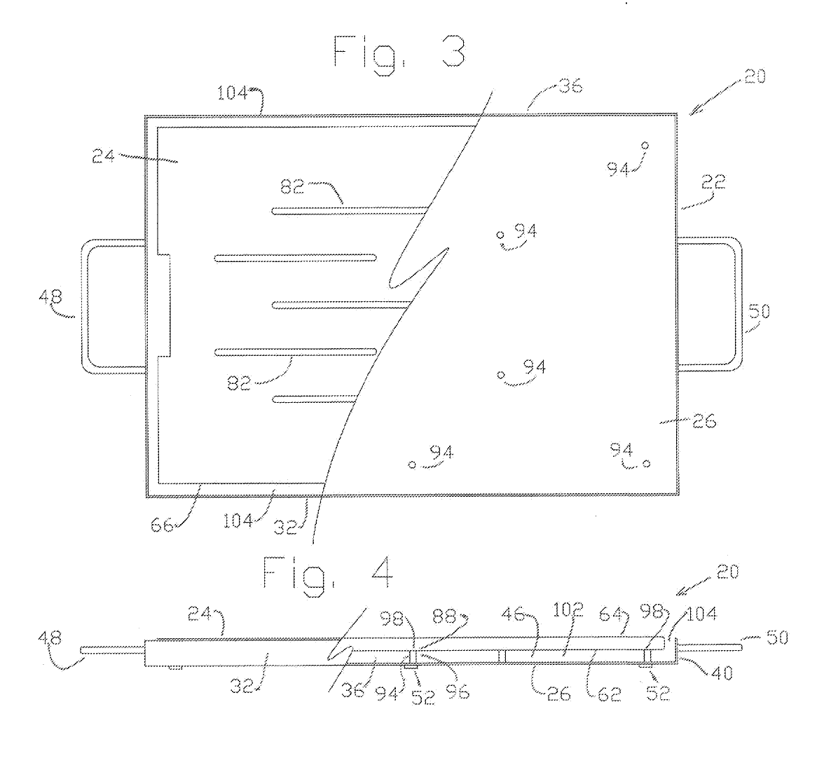

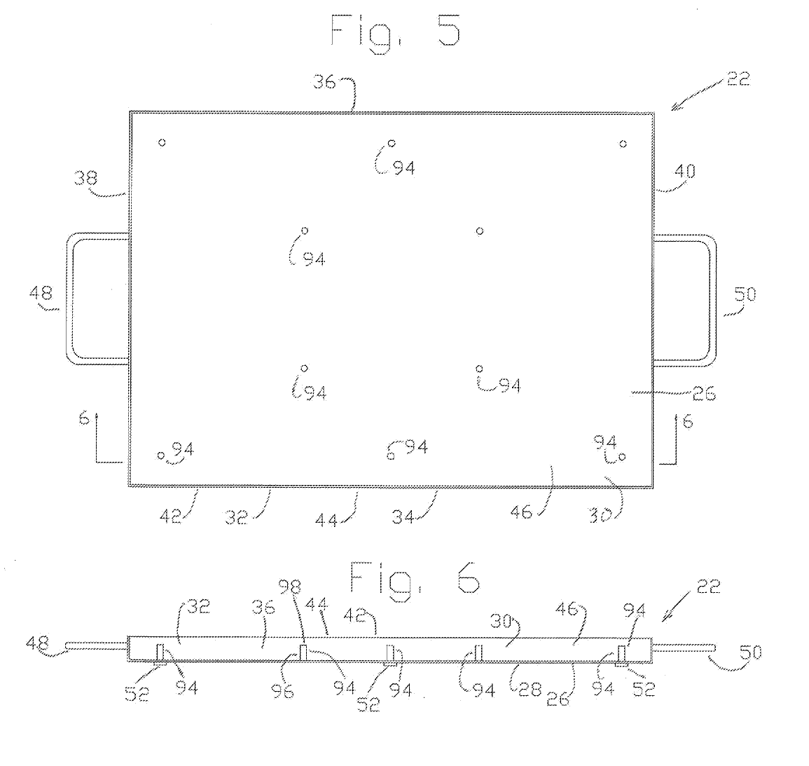

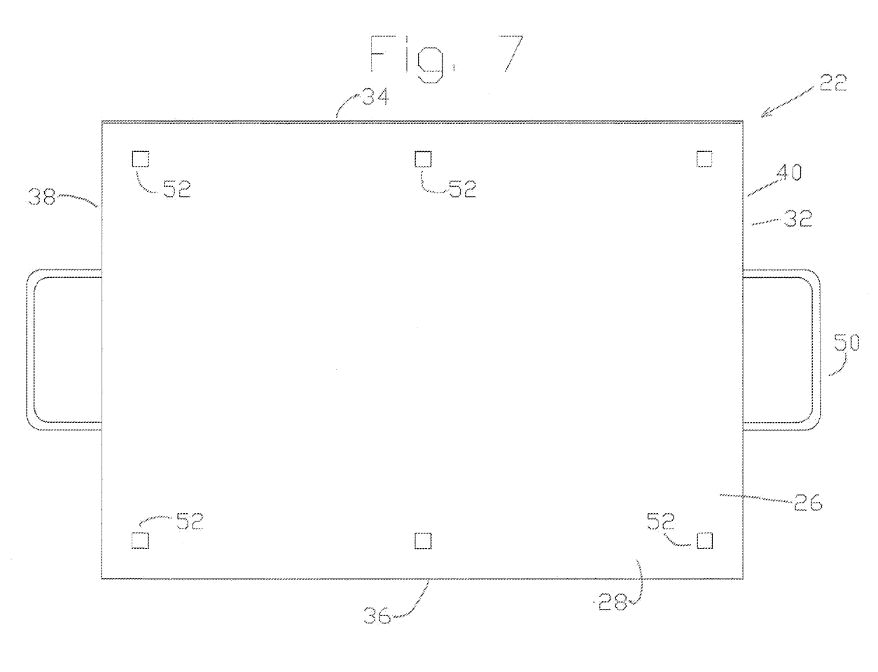

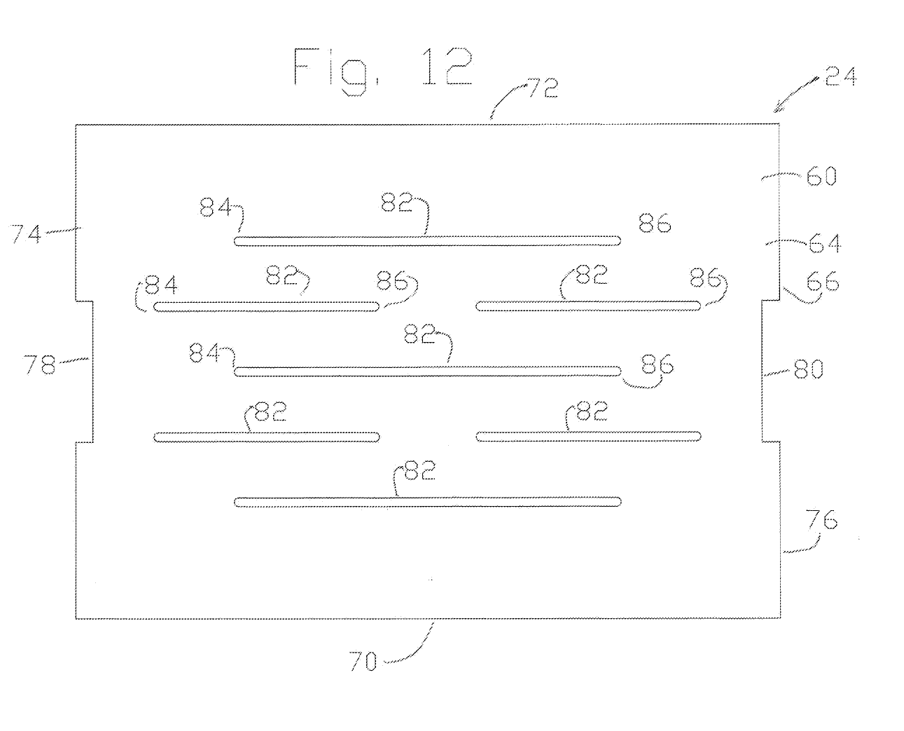

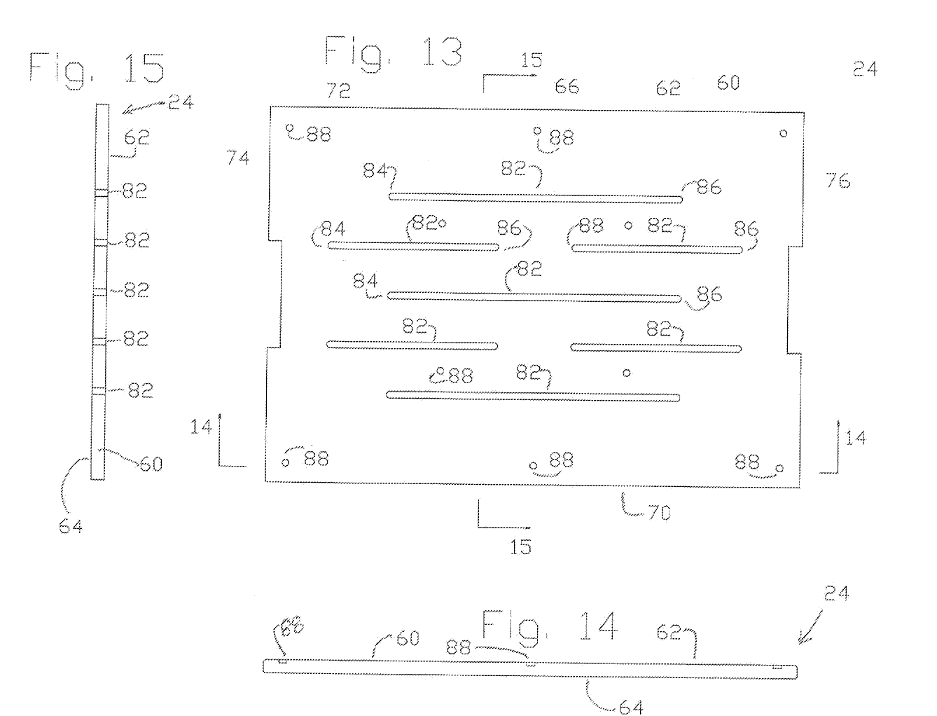

The present disclosure relates to a cutting board assembly for use in the cutting and preparation of food products and other items. An embodiment of tire cutting board assembly Is shown in FIGS. 1-7 and 12-15 as cutting board assembly 20. Cutting board assembly 20 includes a drip tray 22 and a cutting board 24 that is removably associated with drip tray 22.

Drip tray 22 includes a generally planar plate-like bottom wall 26 having a generally planar bottom surface 28 and a generally parallel and planar top surface 30. Drip tray 22 also includes a peripheral side wad 32 comprising a plurality of side wall portions, sock as a generally planar front side wall 34, a generally planar rear side wall 36 that is spaced apart from and generally parallel to front side wall 34, a generally planar left side wall 38, and a generally planar right side wall 40 feat is spaced apart from and generally parallel to left side wall 38. Left side wall 38 arm right side wall 40 extend generally perpendicular to front side wall 34 and rear side wall 36 and respectively between opposite ends of from side wall 34 and rear side wall 36, such that side walls 34, 36, 38 and 40 extend around the peripheral, edge of bottom wall 26. Each side wall 34, 36, 38 and 40 has a generally linear bottom edge attached to an edge of bottom wall 26 and extends upwardly to a generally linear top edge 42. Top edges 42 of side walls 34, 36, 38 and 40 form a peripheral, top edge 44 of peripheral side wall 32. Drip tray 22 includes a receptacle 46 formed within side walls 34, 36, 38 and 40 of peripheral side wall 32 and above bottom wall 26.

Drip tray 22 may include a first handle 48 attached to an outside surface of led side wall 38 and a second handle 50 attached to an outside surface of right side wall 40 to facilitate moving or carrying drip tray 22 by itself or with cutting board 24. As shows in FIG. 7, drip tray 22 may include a plurality of feet 52 attached to bottom surface 28 of bottom wall 26. Each foot 52 may be formed from a slip-resistant material, such as an elastomeric material. Feet 52 are adapted to support drip tray 22 on a support surface, such as the surface of a countertop or table, such that bottom surface 28 of bottom wall 26 is spaced apart from and above the support surface. Feet 52 are also adapted to inhibit horizontal slipping movement of drip tray 22 on the support surface and to inhibit marring or scratching of the support surface. Drip tray 22 and peripheral side wall 32 are shown as being generally rectangular in plan view, but may be formed as a square, a circle, an oval or other shapes. Drip tray 22 may be formed from a metal, such as stainless steel, or a plastic material.

Cutting board 24 includes a plate-like body 60 having a generally planar bottom surface 62, a spaced apart and generally parallel and planar top surface 64, and a peripheral side wall 66 that extends around, the perimeter of body 60 and between bottom surface 62 and top surface 64. Peripheral side wall 66 forms a peripheral edge of body 60 and ton surface 64 and includes a generally linear front side wall 70, a generally linear rear side wall 72, a generally linear led side wall 74, and a generally linear right side wall 76 arranged In a generally rectangular manner. Peripheral side wall 66 may extend generally planar or in a curved manner between bottom surface 62 and top surface 64. Left side wall 74 may include an inwardly extending notch 78 and tight side wall 76 may include an inwardly extending notch 80. Notches 78 and 80 are adapted to facilitate manual gripping and handling of cutting board 24. Alternatively, cutting board 24 may include a plurality of apertures, with each aperture adapted to receive one or more fingers of a user, for gripping and handling cutting board 24.

Cutting board 24 includes a one or more elongate slots 82. Each slot 82 extends generally linearly between a first end 84 and a second end 86. Each slot 82 extends through body 60 of cutting board 24 from top surface 64 to bottom surface 62. Slots 82 may be spaced apart and parallel to one another and/or spaced apart and axially aligned with one another, or in such other arrangements as may be desired. Cutting board 24 may alternatively or additionally include one or more apertures, such as circular apertures, that extend through body 60 from top surface 64 to bottom surface 62. As shown in FIG. 13, body 60 of ending board 24 may include a plurality of detents 88 formed in bottom surface 62. Cutting board 24 may be formed from a plastic material and may be one of various different colors. A plurality of cutting boards 24, each of a different color to signify use with a particular type of food product, may be interchangeably used and associated with drip tray 22. Cutting board 24 may include a plurality of feet on bottom surface 62 for spacing bottom surface 62 from a support surface when cutting board 24 Is placed on a support surface separately and apart from drip tray 22.

Cutting board assembly 20 includes a plurality of spaced apart support members 94 located hi receptacle 46 of drip tray 22. Each support member 94 includes a bottom end 96 attached to bottom wall 26 of drip tray 22 and a top end 98. Support members 94 extend upwardly from and generally perpendicular to bottom wall 26. Cutting board 24 is removably associated with receptacle 46 of drip tray 22 such that cutting board 24 is removably supported above and spaced apart from bottom wall 26 of drip tray 22 on top ends 98 of support members 94. Bottom surface 62 of cutting board 24 removably engages top ends 98 of support members 94. Top end 98 of each support member 94 is adapted to be received, in a respective detent 88 in bottom surface 62 of cutting board 24 to inhibit horizontal movement of cutting board 24 with respect to drip try 22. Each support member 94 may comprise a generally cylindrical post. Alternatively, support members 94 may be connected to bottom surface 62 of cutting board 24 and be removably engageable wind bottom wall 26 of drip tray 22.

Support members 94 removably engage bottom surface 62 of cutting board 24 within receptacle 46 of drip tray 22 such that bottom surface 62 of cutting board 24 is spaced apart and generally parallel to and above top surface 30 of bottom wall 26 of drip tray 22, such that a liquid reservoir 102 is formed/within receptacle 46 between bottom wall 26 and bottom surface 62 of cutting board 24 that is adapted to receive liquid from the food product. Bottom, surface 62 of cutting board 24 may be located within receptacle 46 of drip tray 22, and top surface 64 of cutting board 24 may be located above top edge 42 of peripheral side wall 32, when cutting board 24 is associated with receptacle 46 and is supported by support members 94.

Cutting board 24 is sized and configured to fit within peripheral side wall 32 and receptacle 46 of drip tray 22 with a peripheral gap 104 formed between peripheral side wall 66 of cutting board 24 and peripheral side wall 32 of drip tray 22. Peripheral gap 104 may extend around the entire perimeter and peripheral edge of ceding board 24. Gap 104 is in fluid communication with receptacle 46 and liquid reservoir 102, and slots 82 of cutting board 24 are in fluid communication with receptacle 46 and liquid reservoir 102, when cutting board 24 is associated with receptacle 46.

When cutting board 24 is associated with drip tray 22 and is supported by support members 94 above bottom wall 26, one or more food products may be placed upon and supported by top surface 64 of cutting board 24 for resting or further processing, such as by cutting, chopping, rinsing, basting and the like. The food product may comprise meat, seafood, fruit, vegetables and the like. When the food product is supported on top surface 64 of cutting board 24, internal liquid such as juices or water, may be released from the food product when the food product is resting on cutting board 24 or is being further processed, such as by cutting or chopping, on cutting board 24. In addition, external liquid, such as water, juices, basting liquid, gravies and sauces, may be released from the external surface of the food product. Such liquids that are released from the food product How onto top surface 64 of cutting board 24, and will then flow through slots 82 in cutting board 24 into liquid reservoir 102 of drip tray 22 and/or will flow over the edges of cutting board 24 and through gap 104 into liquid reservoir 102 of drip tray 22. Drip tray 22 collects and retains the liquid released from the food product in receptacle 46 and prevents spillage of the released liquid onto a support surface for the drip tray 22 or onto the floor. Cutting board 24 may be removed from drip tray 22, with or without the food product on top surface 64, and placed on a support surface. Drip tray 22, with the collected liquid, may then be manually handled to pour the collected liquid from receptacle 46 into a pot, pan, container or the like for further use, such as in making sauces or gravies, or for storage or disposal.

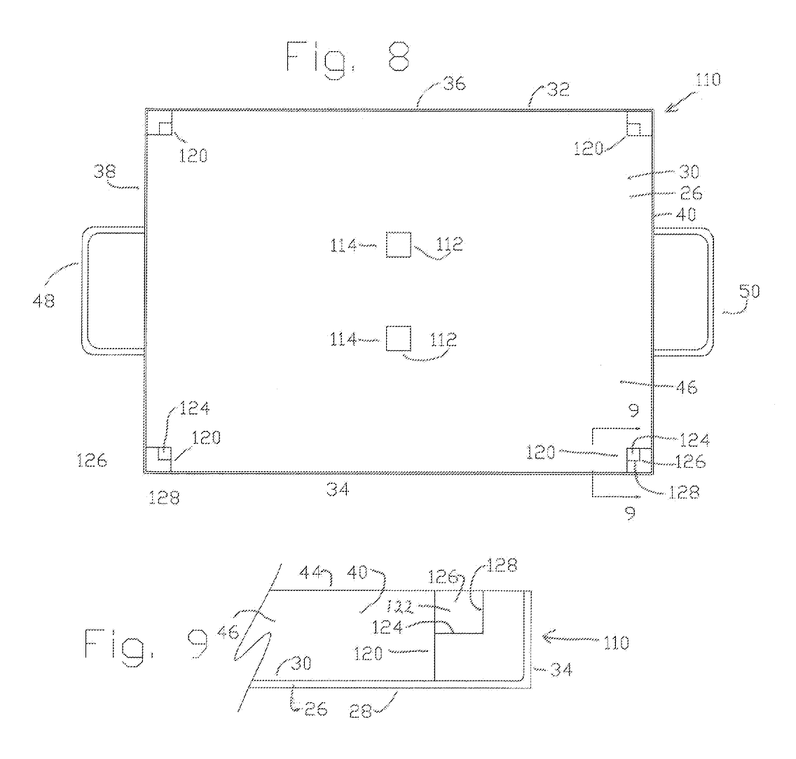

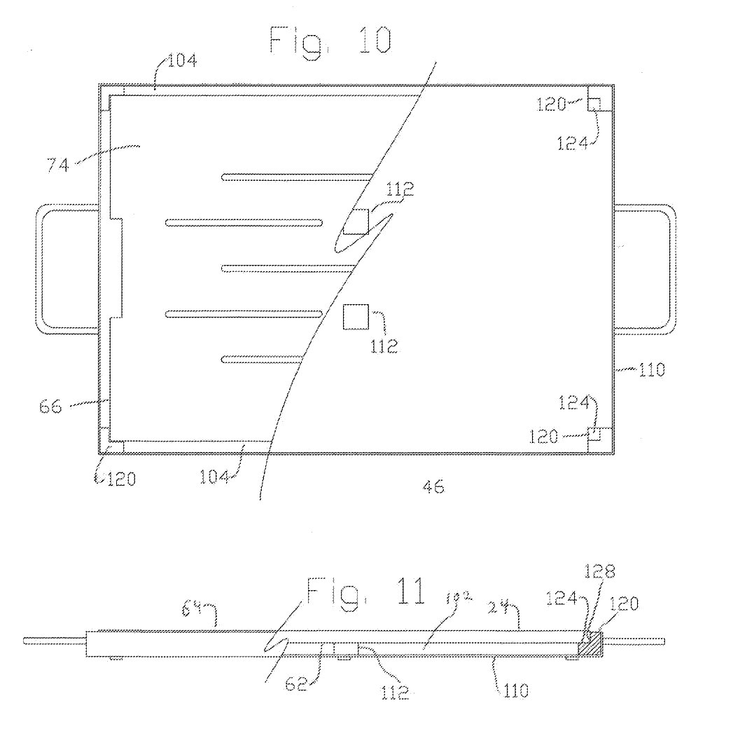

An alternate embodiment of drip tray 22 is shown in FIGS. 8-9 as drip tray 110. Elements common to drip tray 22 and drip tray 110 are identified with the same reference number. Drip tray 110 may include one or more central support members 112 having a bottom end attached to bottom wall 26 and that extend upwardly from bottom wall 26 to a top end 114 having a generally planar top surface adapted to releasably engage and support bottom surface 62 of cutting board 24. Central support members 112 are spaced apart from peripheral side wall 32 of drip tray 110 and are located within receptacle 46.

Drip tray 110 may also include a plurality of peripheral support members 120. Each peripheral support member 120 is located adjacent bottom wall 26 and adjacent peripheral side wall 32, such as in a corner of peripheral side wall 32 wherein two side wall portions of peripheral side wall 32 meet. Each peripheral side wall support 120 includes a scat 122. Seat 122 includes a generally horizontal support surface 124 adapted to releasably engage and support bottom surface 62 of cutting board 24 above bottom wall 26 and a generally vertical first engagement surface 126 extending perpendicularly upwardly from support surface 124 and spaced apart from and generally parallel to an associated side wall portion of peripheral side wall 32 of drip tray 110. First engagement surface 126 is adapted to releasably engage an associated side wall of cutting board 24 to inhibit horizontal movement of cutting board 24 toward the associated side wall portion of peripheral side wall 32 of drip tray 110 and to maintain gap 104 between cutting board 24 and peripheral side wall 32 of drip tray 110.

Seat 122 of peripheral support member 120 may also include a generally vertical second engagement surface 128 extending perpendicular to and upwardly from support surface 124 and extending generally perpendicularly from first engagement surface 126. Second engagement surface 128 is located generally parallel to and associated with another side wall portion of peripheral side wall 32 of drip tray 110. Second engagement surface 126 is adapted to engage an associated side wall of crating board 24 to inhibit horizontal movement of cutting board 24 toward the associated side wall portion of peripheral side wall 32 and to maintain gap 104 between cutting board 24 and peripheral side wall 32 of drip tray 110. Cutting board 24 is removably supported by support members 112 and 120 above bottom wall 26 of drip tray 110. Peripheral support members 120 inhibit horizontal movement of cutting board 24 with respect to drip tray 110 while allowing carting board 24 to be removable and replaceable in association with drip tray 110.

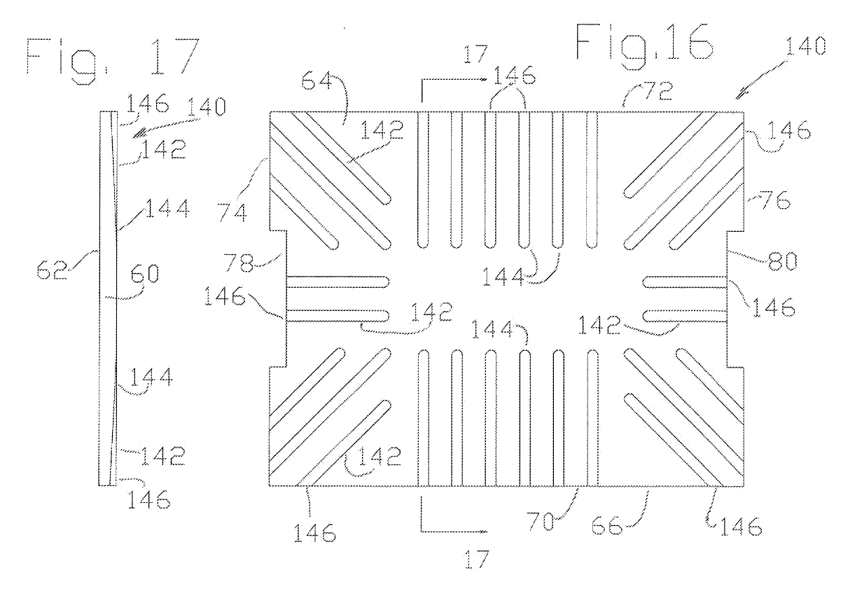

An alternate embodiment of cutting board 24 is shown in FIGS. 16 and 17 as cutting board 140. Elements common to cutting board 24 and cutting board 140 are identified with the same reference number. Cutting board 140 includes a plurality of elongate grooves 142 formed in top surface 64 of body 60. Each groove 142 extends between a first end 144 and a second end 146. Each groove 142 may extend generally linearly between first end 144 and second end 146. First end 144 of each groove 142 is spaced apart from the edge or peripheral side wall 66 of cutting board 140. Second end 146 of each groove 142 is located at the edge or peripheral side wall 66 of cutting board 140 and is in fluid communication with gap 104 between cutting board 140 and peripheral side wall 32 of drip tray 22 or 110 when cutting board 140 is associated with drip tray 22 or 110. Each groove 142 increases in depth with respect to top surface 64 as groove 142 extends from last end 144 to second end 146. Each groove 142 thereby forms a fluid flow channel that drains liquid therein from first end 144 to second end 146 and into gap 104 and liquid reservoir 102. If desired, cutting board 140 may also include one or more slots 82.

The cutting board assembly of the present disclosure may be implemented in a variety of configurations or sizes, using certain aspects of the several embodiments described herein and other know art. Thus although the invention has been herein shown and described in what is perceived to be the most practical and preferred embodiments, it is to be understood that the invention is not intended to be limited to the specific features and embodiments set forth above. Rather it is recognized that modifications may be made by one of skill in the an of the invention without departing from the spirit of the invention and, therefore, the invention is to be taken as including all reasonable equivalents to the subject matter disclosed herein.

1. A cutting board assembly for as with a food product, said cutting board assembly comprising:
a drip tray including a bottom wall and one or more side walls forming a receptacle;
a cutting board having a top surface, a bottom surface, a peripheral edge, and one or more slots extending through said cutting board from said top surface to said bottom surface, said top surface adapted to support the food product, said cutting board adapted to be removably associated with said receptacle of said drip tray;
whereby liquid released from the food product, when the food product is supported on said top surface of said cutting board, may flow through said slots in said cutting board and into said receptacle of said drip tray, said cutting board being selectively removable from said drip tray such that the liquid released from the food product remains in said receptacle of said drip tray alter removal of said cutting board from said drip tray.

2. The cutting board assembly of claim 1 including a plurality of support members adapted to extend between said drip tray and said cutting board said support members adapted to space said bottom surface of said cutting board from said bottom wall of said drip tray such that a liquid reservoir is located within said receptacle of said drip tray between said bottom wall of said drip tray and said bottom surface of said cutting board for the collection of liquid that flows through said slots of said cutting board.

3. The cutting board assembly of claim 2 wherein each said support member includes a first end coupled to said bottom wall of said drip tray and a second end adapted to releasably engage said bottom surface of said cutting board.

4. The cutting board assembly of claim 3 wherein said bottom surface of said cutting board includes a plurality of detents, each said detent adapted to removably receive said second end of a support member.

5. The cutting board assembly of claim 1 including a gap formed between said peripheral edge of said cutting board and said one or more side walls of said drip tray when said cutting board is associated with said receptacle of said drip tray, said gap being in fluid communication with said receptacle of said drip tray such that the liquid from the food product may flow through said gap into said receptacle.

6. The cutting board assembly of claim 5 wherein said gap extends around said peripheral edge of said cutting board.

7. The cutting board assembly of claim 2 wherein each said support member comprises a generally cylindrical post.

8. The cutting board assembly of claim 2 wherein each said support member comprises a seat adapted to receive said peripheral edge of said cutting board, said seat including a support surface adapted to releasably engage said bottom surface of said cutting board and a first engagement surface adapted to engage said peripheral edge of said cutting board and to space said peripheral edge of said cutting board with respect to said one or more side walls of said drip tray.

9. The cutting board assembly of claim 8 wherein each said seat member includes a second engagement surface disposed at an angle to said first engagement surface, said second engagement surface adapted to engage said peripheral edge of said cutting board and to space said peripheral edge of said cutting board with respect to said one or more side walls of said drip tray.

10. A cutting board assembly for use with a food product, said cutting board assembly comprising:
a drip tray including a bottom wall and one or more side walls forming a receptacle;
a cutting board having a top surface, a bottom surface and a peripheral edge, said top surface adapted to support the food product, said cutting board adapted to be removably associated with said receptacle of said drip tray such that a gap is formed between said peripheral edge of said cutting board and said one or more side walls of said drip tray, said gap being in fluid communication with said receptacle of said drip tray;
whereby liquid released from the food product, when the food product is supported on said top surface of said cutting board, may flow over said peripheral edge of said cutting board and through said gap into said receptacle of said drip tray, said cutting board being selectively removable from said drip tray such that the liquid released from the food product remains in said receptacle of said drip tray after removal of said cutting board from said drip tray.

11. The cutting board assembly of claim 10 including a plurality of support members extending between said drip tray and said cutting board, said support members adapted to space said bottom surface of said cutting board from said bottom wall of said drip tray such that a liquid reservoir is located within said receptacle of said drip tray between said bottom wall of said drip tray and said bottom surface of said cutting board for the collection of liquid that flows through said gap.

12. The cutting board assembly of claim 11 wherein each said support member includes a first end coupled to said bottom wall of said drip tray and a second end adapted to releasably engage said bottom surface of said cutting board.

13. The cutting board assembly of claim 10 wherein said gap extends around said peripheral, edge of said cubing board.

14. The cutting board assembly of claim 11 wherein each said support member comprises a seat adapted to receive said peripheral edge of said cutting board, said seat including a support surface adapted to releasably engage said bottom surface of said cutting board and a first engagement surface adapted to engage said peripheral edge of said cutting board and to space said peripheral edge of said cutting board with respect to said one or more side walls of said drip tray.

15. The cutting board assembly of claim 14 wherein each said seat member includes a second engagement surface disposed at an angle to said first engagement surface, said second engagement surface adapted to engage said peripheral edge of said cutting board and to space said peripheral edge of said ending board with, respect to said one or more side walls of said drip tray.

16. The cutting board assembly of claim 10 wherein said top surface of said cutting board includes one or more grooves, each said groove extending between a first end and a second end, said second end of each said groove being located at said peripheral edge of said cutting board and in fluid communication with said gap and said receptacle of said drip tray when said cutting board is associated with said drip tray, such that liquid released from the food product may flow along said groove and into said gap and thereby into said receptacle of said drip tray.

17. The cutting board assembly of claim 16 wherein each said groove includes a depth with respect to said top surface of said cutting board that increases as said groove extends from said first end of said groove toward said second end of said groove.

18. The cutting board assembly of claim 10 wherein said cutting board includes one or more slots extending through said cutting board from said top surface to said bottom surface of said cutting board.

19. A culture board for supporting a food product and for association with a drip tray having a receptacle, said cutting board comprising:
a top surface, a bottom surface and a peripheral edge, said top surface adapted to support the food product, and one or more grooves formed in said top surface of said cutting board, each said groove extending between a first end and a second end, said second end of each said groove being located at said peripheral edge of said cutting board such that said second end of said groove is adapted to be in fluid communication with the receptacle of the drip tray when said cutting board is associated with the drip tray and such that liquid released from the food product may flow along said groove and into the receptacle of the drip tray.

20. The cutting board assembly of claim 19 wherein each said groove includes a depth with respect to said top surface of said cutting board that increases as said groove extends from said first end of said groove toward said second end of said groove.
